(19) United States
(12) Patent Application Publication
(10) Pub. No.: US 2007/0095203 A1
(43) Pub. Date: May 3, 2007

(54) Method to Remove an Agent Using a Magnetic Carrier from the Gaseous Phase of a Process

(76) Inventors: Henry G. Paris, Chattanooga, TN (US); Xing Dong, Chattanooga, TN (US)

Correspondence Address: BUTLER, SNOW, O'MARA, STEVENS & CANNADA PLLC, 6075 POPLAR AVENUE, SUITE 500, MEMPHIS, TN, 38119, US

(21) Appl. No.: 11/539,303

(22) Filed: Oct. 6, 2006

Related U.S. Application Data
(60) Provisional application No. 60/724,459, filed on Oct. 7, 2005.

(51) Int. Cl. B03C 1/015

(52) U.S. Cl. 95/28

(57) ABSTRACT

The subject of the invention is a process for removal or separation of agents from dynamic process systems, particularly when the agent may be hazardous. Its primary embodiment lies in the removal of mercury from the exhaust from fossil fired heating systems, however, it can be seen as also applicable to many other types of separation processes. The process uses a regenerable and recyclable magnetic substrate having a sorbent attached thereto. The combination of the magnetic substrate and sorbent is referred to as a magnetic carrier.

### RELATED APPLICATIONS

This application claims the benefit of U.S. Provisional application Ser. No. 60/724,459 filed Oct. 7, 2005 (hereby specifically Incorporated by reference).

### FIELD OF THE INVENTION

The present invention relates generally to the field of removal of an agent, such as mercury, from process systems, such as fossil fuel electric generating systems.

### BACKGROUND OF THE INVENTION

Mercury is an impurity at low concentration in the earth's crust. Mercury is present in three basic forms, metallic, inorganic mercury in Hg⁺¹ or Hg⁺² valence state (e.g. as an inorganic chloride) and organic mercury bound to phenyl-, alkoxyalkll-, or methyl- groups. Methyl mercury and elemental mercury are most hazardous forms.

The source of a large proportion of mercury pollution comes from burned coal. Coal forms by the combination of long-term putrefaction and pressurization under reducing conditions of prehistoric buried organic plant matter. It is easy to see how mercury may find its way into coal given the nature of the natural process that makes coal and the high solubility of mercury in organic solvents. The solubility of mercury in benzene, heptane, isopropyl ether and iso-octane is between ˜1-2.5 mg/1; and its solubility in water is ˜0.064mg/1. While mercury exists in very small concentration in coal, the massive volume of coal burned for power generation yields a significant (˜>40%) over-all emission of mercury into the environment.

The two prevalent classifications of coal are bituminous and brown (lignite or sub-bituminous). Bituminous coal from the eastern US, contains primarily ionic mercury. Sub-bituminous coal mainly from the western US yields predominately elemental mercury. Sub-bituminous coal is the predominant source of coal.

Because of the two coals and the characteristic of specific power plants, the boiler releases mercury in both forms, ionic and elemental. Downstream wet scrubbers more readily remove the ionic form, and the elemental form is more difficult to remove. Most methods to remove it aim to convert all the mercury to an ionic form.

Approaches to Mercury Removal in Power Plant Flue Gas:

EPRI discusses a number of approaches to remove mercury from flue gas. (http://www.epriweb.com/public/EPRI_MC_diagram.swf). The steps in the power plant generation involve feeding coal to the combustor, combustion of coal, collection of flue gas, removal of NOX and particulate, removal of SOX and exhaust to the environment. The complicating factor is that coal-fired power plants are of varying age and some have only part of the pollution abatement methods described next, or none at all, depending on age and location. The pollution abatement methods address removal of the contaminate stream from combustion of coal. The waste stream comprises, NOX and SOX, coarse ash, fine fly ash, CO₂ and mercury.

An important consideration is how removal of mercury impacts the quality of fly ash and effluent from SOX removal. Primary markets for particulate byproducts of coal combustion are fly ash as an additive to cement or concrete, and gypsum (calcium sulfate from SOX removal) for wallboard and soil amendments. If mercury is bound to fly ash or enters the SOX scrubbers it may ruin the ash or gypsum for these applications. The following options provide methods to remove mercury.

Clean the Coal Before It Is Burned. Bituminous coal is cleaned routinely prior to combustion to remove non-combustibles. Although not intended for the purpose, this cleaning removes up to ˜35% of the mercury. EPRI states it is unlikely to achieve a higher reduction in mercury in bituminous coal by cleaning. Sub-bituminous coal is usually not cleaned. De-watering processes under development for sub-bituminous coal may have the potential to remove ˜<70% of the mercury in western coal.

Additives To Oxidize Mercury During Burning. Scrubbers and other methods described in the following sections can remove mercury converted to ionic form. Ionized mercury is more easily removed by conventional adsorbents. A typical strategy adds oxidizers (salts such as chloride) to do this conversion to ionic form.

Modify the Combustion Process. Activated carbon is effective to remove mercury. Increasing the content of un-oxidized carbon in the flue gas by modifying the combustion process enhances more thorough removal of the mercury in this manner. In such a case, the mercury-laden particulate is collected in the fly ash. Increased mercury content in the fly ash renders the ash unusable. Changing the oxidation/reduction character of the combustion process leads to lower efficiency.

Selective Catalytic Reduction (SCR). Another approach would oxidize mercury using the SCR that converts NOX. Down stream wet scrubbers would collect the oxidized mercury. An alternate approach is to use a mercury-selective catalyst for this purpose. Mercury-selective catalysts typically involve a “fixed absorbent structure.” These are plates or channels lined with the catalyst. Typical active materials are gold, sulfur and activated carbon (technically these act as adsorbents since the mercury is bound to the “adsorbent structure”). A major issue with SCR for oxidation of mercury is whether such devices can maintain selective oxidative power approaching the typical expected life of the catalyst of ˜12,000-16,000 hours (12-22 mo.)

Sorbent Injection. Modified activated carbon is a very good sorbent of mercury, but has the drawback of higher cost. EPRI implies the cost of activated carbon is an issue. An EPRI publication cites short-term tests that removed up to 80-85% of mercury from bituminous coal fired plant by injecting activated carbon as a fine powder in the flue gas. However, the removal of mercury in western coals peaks at 65-70%. (http://www.epriweb.com/public/EPRI_MC_diagram.swf). This method requires injection of a quantity of carbon “dust.” A further complication of using this method, or any method that injects activated carbon upstream, is that the carbon with adsorbed mercury contaminates the collected ash in the latter stages of the flue gas cleaning process, rendering the fly ash commercially useless for the largest current application, a substitute for cement in concrete. Nucon claims 99% removal of mercury using sulfur added activated carbon in lab tests. (http://www.nucon-int.com/MercuryRemoval/INEEL/Mercury Removal.pdf). EPRI suggests lower percent efficiency.

Results of long-term tests are not available. The durability of the process is not well known and is an area of active development. The necessity to control location of the injection into the waste steam to avoid contaminating the fly ash with mercury is a disadvantage. The carbon might be injected after the ESP to avoid contaminating fly ash, but this still requires a “polishing ” fabric filter to remove the carbon holding the captured mercury. Filters may increase back pressure of the flue.

Electrostatic Precipitators. ESP is virtually useless for removing mercury unless some upstream process is used to bind mercury to particulate, i.e., activated carbon injection. Typical efficiency for mercury removal is ˜0-35% for ESP without particulate binding. The efficiency of fabric filters increases removal to 35-99% for bituminous coal and ˜48-86% for sub-bituminous coal. When sorbents are used, ESP/FF lead to mercury in the fly ash. As mentioned previously, this makes the fly ash valueless as a concrete additive.

Polishing filters. “TOXECON™” is a filter under development. It claims 85-95% efficiency in short term tests.

FGD (Flue Gas Desulphurization) Additives and Scrubbers. This technology is one in which active material is injected into the liquid in the SOX scrubber. The additive reacts with the mercury to form non-volatile salts. The key is the reaction must be fast enough avoid contaminating the calcium sulfate that forms in reaction with the slurried limestone to prevent contamination of the resultant gypsum. This is a developing technology. Scrubbers, or FGD, remove SOX, primarily as sulfate. The FGD will remove ˜90-95% of ionic mercury, but little or any elemental mercury.

Fixed Absorption Structure. Plates or honeycomb structures with mercury adsorbent materials such as gold or activated carbon are placed in the flue gas stream. There are little hard results in this area.

### SUMMARY OF THE INVENTION

The present invention provides a method to remove an agent from a gas phase of a process system by suspending a magnetic carrier in the gas phase of a process system, under the condition in which the agent binds to the magnetic carrier. The present invention also provides a method by magnetically separating the magnetic carrier from the gas phase and disassociating the agent from the magnetic carrier. The magnetic carrier can be reused to remove additional agents from the gas phase of the process system.

More specifically, the present invention has advantages that improve the function of an adsorbent as well as how a sorbent is dispersed, maneuvered and removed from a gas stream. The present invention provides as a regenerable and recyclable sorbent attached to a magnetic substrate that can be separated from the gaseous exhaust stream. This provides considerable economic advantage that can reduce the cost of sorbent and thus, the removal of agents,and works on unoxidized forms of mercury.

### TECHNICAL ASPECTS OF THE INVENTION

From a technical point of view, the present situation addresses a situation where mercury is removed from the effluent of a fossil fuel electric generating system. In the prior art, sorbents bound to a solid phase such as activated carbon, plates or channels have been used to remove mercury from the effluent. These prior art methods are not completely satisfactory for removing mercury because conventional adsorbents, such as activated carbon, sulfur and elemental gold have particular problems including expense, polluting the fly ash, and performance issues even when they demonstrate high efficiency at removing mercury from the gas stream. The main reason appears to be that the specific adsorbents work only, or best with mercury in its oxidized state and do not work very well in its unoxidized, or elemental vapor state. This problem is solved by the use of a magnetic carrier of sufficiently small size to be suspended in the gas effluent. The magnetic carrier is functionalized to bind mercury. It is also, superior to the prior art in that it is reusable. It also provides an enhanced adsorption in the gas phase not obtained using a nonmagnetic carrier such as silica or zeolite.

### BRIEF DESCRIPTION OF THE DRAWINGS

These and other features, aspects and advantages of the present invention will become better understood with regard to the following descriptions, appended claims and accompanying drawings wherein:

FIG. 1 is a block diagram of the process.

FIG. 2 shows a schematic drawing of a magnetic substrate drawing of a magnetic substrate.

FIG. 3A is a photograph of a magnetic particle.

FIG. 3B is a photograph of a magnetic particle.

FIG. 4 is a photograph of a group of magnetic particles.

FIG. 5 is photograph of a magnetic particle.

FIG. 6A is a photograph of a magnetic particle.

FIG. 6B is a photograph of a magnetic particle.

FIG. 7 is a photograph of a functionalized magnetic particle.

FIG. 8 is a schematic diagram of the process to circulate the magnetic carrier.

FIG. 9A is an axis view of a magnetic containment reactor.

FIG. 9B is a longitudal view of a magnetic containment reactor.

FIG. 10 is the performance of magnetic carriers in dry nitrogen.

### DETAILED DESCRIPTION OF THE INVENTION

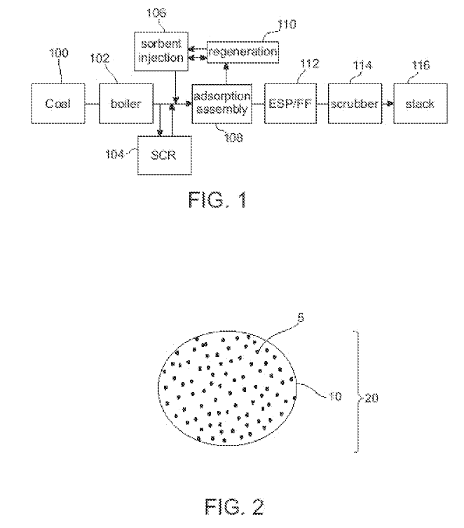

Referring now to the drawings, wherein like numerals have been listed for similar elements throughout. FIG. 1 illustrates a coal-fired utility boiler installation of the type used by utilities in the generation of electric power, and which represents one type of industrial process to which the present invention is applicable. In its broadest form, the present invention relates a method for removing mercury from the flue gas generated during the combustion of fossil fuels or solid wastes through the use of a magnetic substrate. Of course, while the aforementioned coal-fired utility boiler installations are but one example, and the method of the present invention will likely first find commercial application to the removal of mercury from the flue gasses produced by such utility boiler installations which combust such fossil fuels, any industrial process using a wet scrubber or other type of absorber module to purify such flue gases may benefit. Such processes could include incineration plants, waste to energy plants, or other industrial processes which generate gaseous products containing mercury. Thus for the sake of convenience, the terms industrial gas, flue gas, or just gas will be used in the following discussion to refer to any gas from an industrial process and from which an objectionable component, such as mercury, is to be removed.

Referring now to FIG. 1, the typical flow stream of a coal-fired boiler installation of the type used by utilities in the generation of electric power is shown. Coal 100 is added to boiler 102 under conditions to facilitate combustion of the coal. As part of this combustion flue gas is generated. Flue gas produced by the combustion process is conveyed to downstream to flue gas clean-up equipment. In the present embodiment shown in FIG. 1, SCR technology 104 is used for selective catalyst reduction of NOX. Additionally, sorbent injection 106 is used to reduce mercury in the flue gases. Such absorbents may be silver or sulfur containing ligands such as a thiol group attached to activated alumina, ferrite or others, or ferrites with modified mesoporous surfaces and a high surface density of organo-silicon moieties used to attach suitable catalysts.

The magnetic carrier 20 is added to the adsorption assembly 108 to remove mercury. The magnetic carrier 20 is disassociated from the bound mercury in the regeneration process 110. The magnetic carrier 20 is reinjected 106 into the gas flue to remove additional mercury. Further contaminants are removed in the electrostatic precipitation/fabric filter process 112 and scrubber process 114 and the remaining gas is expelled out stack 116.

More specifically, FIG. 2 shows a schematic diagram of the magnetic substrate 10. The magnetic substrate 10 can be a particle or fixed plate. The magnetic particle in the preferred embodiment is ferrimagnetic, made mainly of magnetite (ferrous ferrite) or another mixed oxide ferrite such as manganese ferrite. The magnetic particles are in the ranges from about 2 μm to 100 μm; but are preferably about 2-10 μm. The magnetic particles must be sufficiently small in size to be suspended in the gas phase of a process system, such as in a flue gas exhaust stream of a coal fired burner, but not so small that their magnetic moment is reduced so as to interfere with the collection and recirculation system. Very small powder can travel down stream in the flue gas and adversely effect gas filtration systems.

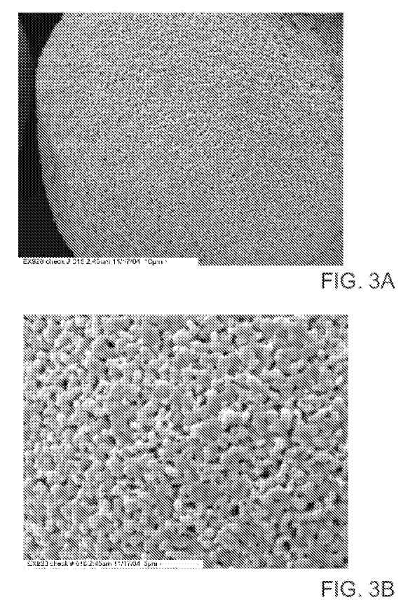

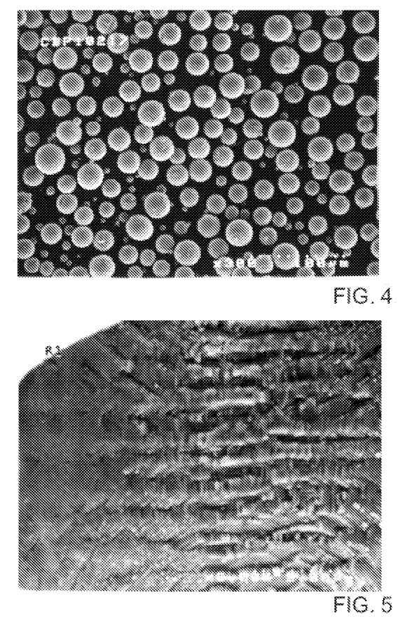

A magnetic substrate 10 can be produced as follows: An aqueous slurry of hematite (d₅₀ on the order of 2-4 μm) that is spray dried into an aggregate (˜30-100 μm) and calcined into an easily handled granular powder. Depending on the specific process steps, e.g., starting milled powder size, time, temperature and atmosphere, a wide range of specific surface area can be created (surface area/unit volume) and varying degree of conversion to magnetite can be achieved. For purposes of making sintered solids, a surface area of no greater than ˜0.1-0.6 m²/g is sought; however this number can be increased significantly up to ˜1-2m²/g or perhaps higher for the current use. FIGS. 3 A & B show an example of this powder.

The magnetic carrier 20 should have a high surface area of at least about 1 m²/gram; but is preferably 100 m²/g or higher and be sufficiently porous to admit the agents to be removed. If the adsorbent relies on chemisorbing, the zero valence species should be oxidized to a reactive state in order to be sufficiently adsorbent.

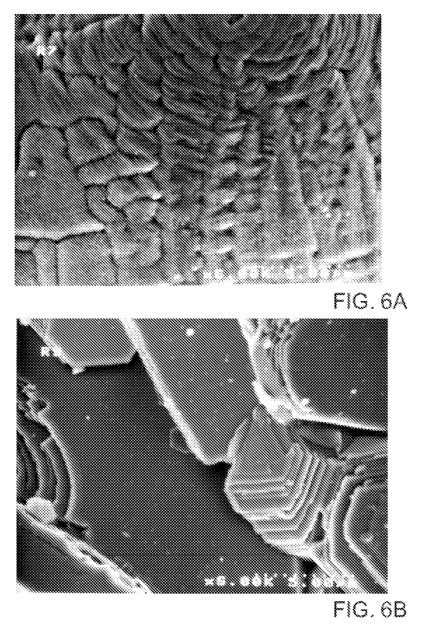

An alternative method to make a magnetite powder is to use plasma processing. U.S. patent application 2003/0209820 (published date Nov. 13, 2003, ¶¶. 22-46) (hereby specifically incorporated by reference in its entirety). This method allows the production of highly spherical powder in sizes from the order of dust (˜10-100nm) up to the approximate size of the sintered spray-dried aggregate discussed in the previous paragraph. The plasma processed powder usually has a highly complex crystallographically faceted, or a dendritic morphology (FIGS. 4-6). The nature of the morphology depends on size of the powder, solidification rate, plasma heat input, substrate and cover gas used in processing the powder. The powder may even have nm-sized hematite attached to its surface. By suitable post-plasma processing the powder morphology can be dramatically changed. The initial solidification microstructure can be recrystallized yielding a smoother surface and if oxidized, ˜30 nm.(FIG. 6).

Now referring again to FIGS. 2 & 7 a sorbent 5, such as an absorbent is attached to the magnetic substrate 10. The magnetic substrate 10 can be surface modified to provide for attachment points for sorbent 5. However, the sorbent 5 can be directly attached to the magnetic substrate 10. The combination of the magnetic substrate 10 with a sorbent 5 is referred to as a magnetic carrier 20.

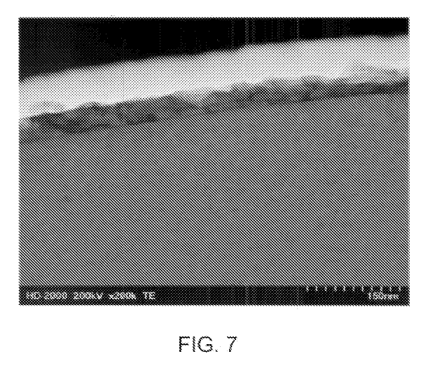

FIG. 4 shows a magnetic substrate 10 powder form that is small enough to be suspended in the gas flow of a flue. The magnetic substrate 10 has its surface suitably modified to allow for anchoring catalyst or absorbent on it to react with the mercury in the flue gas. Alternatively, the magnetic substrate 10 is modified to be a catalyst, that is the ferrite serves to catalyze the absorbing or reaction of mercury. In the first case the catalyst or absorbent particles are very finely dispersed on the surface to allow effective exposure to the gaseous environment, yet firmly held and in sufficient mass to survive on the catalyst surface for useful time. Absorbents or catalysts might be silver, gold, copper or other species known to fix or react with mercury. The surface of the magnetic substrate 10 may be controlled via direct hydrating and silyating the surface, by using the oxide layer shown in FIG. 7.

The requirements for the attachment of the sorbent 5 is (1) that it be sufficiently strong to survive the thermal and abrasive conditions of the flue and (2) that it provide for a high surface area to volume ratio, (3) that it resist poisoning or degradation of the absorbing or catalytic properties of the sorbent 5. Any sorbent 5 that is active for the agent can be used. In the preferred embodiment, the magnetic substrate 10 has sorbents, such as catalyst or adsorbent, that reacts with mercury in flue gas. A number of exemplary choices for mercury are discussed below. A series of patents by Frxyell and co-workers describe catalysts/adsorbents made by attaching mercury-active catalysts to meso-porous silica. These patents address improved methods for attaching silanols to silica substrates and achieving higher density of functional sites. U.S. Pat. No. 6,326,326 describes functional groups to bind mercury and describes the phenomenological method. (Feng, X., Liu, J., Fryxel, G. E., “Surface Functionalized Mesoporous Material and Method of Making Same,” U.S. Pat. No. 6,326,326, Dec. 4, 2001. Fryxell, G. E., Zemanian, T. S., Liu, J, Shin, Y, “Self-assembled Monolayer And Method of Making,” U.S. Pat. No. 6,531,224B1, Mar. 11, 2003. Fryxell, G. E., Zemanian, T. S., Liu, J, Shin, Y., “Self-assembled Monolayer And Method of Making,” U.S. Pat. No. 6,753,038, Jun. 22, 2004. Fryxell, G. E., Zemanian, T. S., Liu, J, Shin, Y., “Self-assembled Monolayer And Method of Making,” U.S. Pat. No.6,733,835 B2, May 11, 2004. Fryxell, G. E., Zemanian, T. S., Liu, J, Shin, Y., “Self-assembled Monolayer And Method of Making,” U.S. Pat. No. 6,846,554 B2, Jan. 25, 2005). (Fryxell, G. E., Zemanian, T. S., Liu, J, Shin, Y, “Self-assembled Monolayer And Method of Making,” U.S. Pat. No. 6,531,224 B1, Mar. 11, 2003). In these works, 3-mercapto-propyltrimetoxysilane is used to form the adsorbent (the mercapto- group) and the attachment. When the substrate is silica, these monolayer films may reach values of SSA of ˜200 m²/g.

Older publications by Aoyama & Sumiya show that both an alkylsilizane and an alkylalkoxysilane (the only difference in the two is the nature of the functional group containing the silicon atom used to anchor the silanol) can be attached to the activated surface of Co-γ-Fe₂O₃. (Aoyma, Shiego and Sumiya, Kenji, Mashiro Amemiya, Journal of Materials Science, vol. 23(1988), p 1729-1734. Aoyma, Shiego and Sumiya, Kenji, “Chemical Adsorption of Silizane on Magnetic Iron Oxide,” Proceedings of the 4^{th} International Conference on Ceramic Powder Processing, Naagoya, Japan, Mar. 12-15, 1991, ed. by Shin-ichi Hirano, Gary Messing and Hans Hauser, The American Ceramic Society, Westerville, Ohio, USA (1991), pp 273-277). In the latter reference, sessile drop experiments with water, ESCA and thermal analysis show that the alkylsilazane forms Si—O chemisorbed bonds to the oxide leaving a strongly hydrophobic surface with the alkyl groups aligned normal to the surface. The silazane is a strongly adsorbed monolayer bound tightly to the substrate. It is superior to the loosely bound alkylalkoxysilane.

The efficiency of the directly functionalized sorbent 5 depends on its attaining a high specific surface area (SSA or surface area/unit volume) on the magnetic substrate 10. The SSA of natural magnetite is usually ˜<1 m²/g. The SSA of magnetite converted from hematite depends greatly on the SSA of the hematite and the specific thermal process. Hematite made by converting iron chlorides in pickle liquor, has intermediate SSA ˜8-10 m²/g, while oxide made from the carbonyl iron process has higher SSA, approaching 18 m²/g. Some chemically converted hematite is reported to have SSA of ˜50m²/g. The average diameter of these powders is on the order of 0.3-3 μm. Small powder is hard to handle so it is usually spray dried to larger size and partially sintered at moderately high temperature under low partial pressure or reducing conditions for handling and conversion to magnetite. The SSA of the hematite influences the SSA of the spray dried powder. When a sample of hematite obtained from the manufacturer AMROX (high purity grade) is given a thermal treatment in a controlled atmosphere (<1000 ppm PO₂ at 800-1000+20C.), it is easy to obtain SSA between 1 and 2 m²/g. Paris, H. G., “Method and apparatus for making ferrite material products and products produced thereby,” U.S. patent application Ser. No. 10/430,948, May 7, 2003 hereby specifically incorporated by reference.

It should be recognized that although silicon-based metallo-organics have good temperature resistance, they still are susceptible to oxidation, carbonizing and nitriding; the terminal compound being either a silica, silicon nitride, silicon carbide, silicon oxycarbide or oxynitride, or other mixed oxides of these compounds. A wide body of literature treats the pyrolysis of the metallo-organic silicon compounds to the ceramic state, examples are contained in the citations. (Trasel, S, Motz, G, Rossler, E, Ziegler, G, “Characterization of the Free-Carbon Phase in Precursor-Derived Si—C—N Ceramics I, Spectroscopic Methods,” J. Amer. Ceramic Soc., vol. 85, No. 1(2002), p 239-24. Motz, G, Ziegler, G, “Simple Processibility of Precursor-derived SiCN Coatings by Optimized Precursors,” 7th Conference of the European Ceramic Society, Brugge/Belgien, 9-13. September 2001, Key Engineering Materials 206-213(2002), p 475-478. Greil, Peter, ″Polymer Derived Engineering Ceramics, Advanced Engineering Materials vol. 2, No. 6(2002), p 339-348). Generally these compounds show increasing cross-linking above about ˜200-300° C., and certainly by 400°C. True conversion to ceramic does not occur until >˜1000° C. A significant amount of nano-scale free carbon can be produced in these materials, especially with di- and tri-functionalized silizanes with gaseous ammonia. While careful pyrolysis and selection of chemistry of the starting polymer may yield a conversion to ceramic, mesoporous surface. A mesoporous material has pore diameter between 20 to 500 Å.

An alternative method whereby the catalyst is anchored to a ceramic substrate via solution processing and calcining may be used. Methods described in patents by Kepner and associates, describe anchored catalysts and adsorbents for removing SOX, NOX and organic compounds. (Moskovitz, M. L., Kepner, B. E., “Adsorbent and/or Catalyst and Binder System and Method of Making Thereof,” U.S. Pat. No. 5,948,726, Sep. 7, 1999. Moskovitz, M. L., Kepner, B. E., Mintz, E. A., “Adsorbent and/or Catalyst and Binder System and Method of Making and Using Thereof,” U.S. patent application No. US2001/0009884 A1, Jul. 26, 2001. Kepner, B. E., Mintz, E. A., “Anchored Cataylst System and Method of Making and Using Thereof,” U.S. Pat. No. 6,342,191 B1, Jan. 29, 2002. Paris, H. G., “Method and apparatus for making ferrite material products and products produced thereby,” U.S. patent application Ser. No. 10/430,948, May 7, 2003). These patents describe various embodiments of anchored systems using colloidal alumina, silica or metal oxide such as iron oxide as a binder and another metal oxide as adsorbent or catalyst. It is difficult to achieve the high specific surface area without using the methods of Fryxell, et al. to create a mesoporous silica substrate. In addition the methods described by the patents of Fryxell, et al, also provide much higher site density of adsorbents on such mesoporous silica substrates.

Although hematite is a preferred embodiment for a starting material to form a ferri-magnetic substrate, other spinel ferrites with substituted transition metal oxides can be used. For example, MnO can be added to form a Mn-Fe ferrite (whose stoichiometric form is give by the formula (MnFe)₃O₄. NiO or other metal oxides may be used as a substitute for MnO, in whole or in part. One advantage of adding these ceramic oxides to make an “alloy” is to provide a change in the Curie Temperature. The Curie Temperature of Fe₃O₄ is 585° C. and the Curie Temperature of MnFe₂O₄ is 300° C. (Table 32.III in Ferrites, J. Smit and H. P. J. Wijn, published by John Wiley & Sons, NY, (1959)) Although one might consider a very high Curie Temperature to be advantageous, the ability to cause a ferrite to spontaneously lose its magnetization can allow a recovery system where in the powder is recovered magnetically and released by heating over its Curie Temperature can be an advantage. By using selective thermal processing and atmosphere control during processing with the current invention, and careful selection of sorbent (which could be the iron oxide or spinel (a mixture of transition metal oxides)), it may be possible to impart strongly ferromagnetic property to the iron oxide making it a useful method for eliminating mercury.

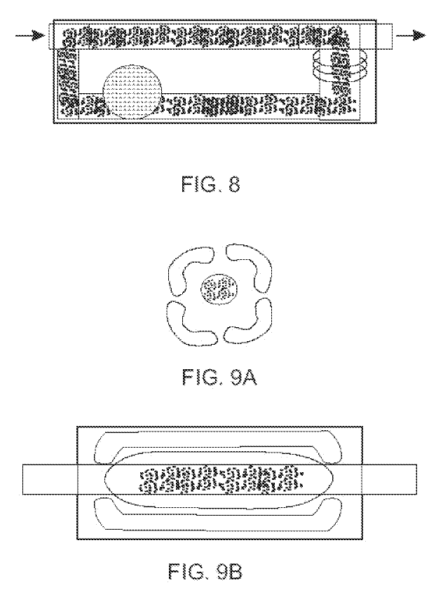

Now referring to FIGS. 8, 9A & 9B, various adsorption assemblies are shown.

In FIG. 8, a re-circulating side stream of fluidized magnetic substrate 20 in powder form within the exhaust stack is magnetically separated at the end of the adsorption assembly 108 and re-circulated to the entry of the adsorption assembly 108. This method allows for direct sampling or metering of mercury and the ability to even direct it in some internal flow pattern but keep it generally inside the containment fields.

Now referring to FIGS. 9A & 9B, a magnetic carrier 20 is suspended in a gas stream using discrete magnetic containment fields designed to keep the magnetic carrier 20 in powder form localized in a “magnetic bottle.” By suspending the powder with the magnetic field it increases the exposure of powder to gas stream. By using a containment field it constrains the powder to a single volume so it can be recovered. By keeping the powder suspended it provides lower back-pressure pressure than methods such as ″catalytic converters that have multiple small passages. This method allows direct sampling of mercury content in the ferrite, and perhaps even directing it in some internal flow pattern while keeping it inside the containment fields.

After collection in the magnetic separator or regenerators, the oxidized mercury can be disassociated from the sorbent using an acid wash, (e.g., 37% (wt.) HCl).

The use of a magnetic carrier 20 provides a unique advantage to avoid contaminating the fly ash with mercury when using surface binding methods for absorbent or catalysis through the use of magnetic separation. In this method the mercury only need be effectively bound to the ferrite and removed in ESP. Since the ferrite is magnetic, a magnetic separation step may be applied in collection of the precipitate to remove the mercury-containing ferrite. Magnetic separation is commonly used in the beneficiation of ores, or to separate non-magnetic and magnetic material in producing carrier bead for electro-photographic copiers. This method would combine a silylated method as described by Frxyell, et al. with a ferrite substrate to make an anchored adsorbent or catalyst system that can replace methods described by example using the patents of Kepner, et al.

The following examples show the effect. All testing was done at nominal 22° C. (room temperature).

### EXAMPLE 1

### Zeolite

A typical high surface area zeolite, MCM-41 (Mobil Technology Corp., Paulsboro, N.J.) was used to demonstrate air adsorption. This adsorbent used a synthetic zeolite support whose starting surface area was 850 m²/g and had a surface area of 358 m²/g after adding the adsorbent ligand, typical of the supercritical gas process. This sample was mixed in roughly equal volume proportion with glass frit and placed in a permeation tube. A mercury source that adds elemental mercury to a dry nitrogen gas stream was used to produce the test stream. The flow rate was adjusted to provide 1.3 seconds dwell time in the adsorbent bed with a elemental mercury concentration of 39 μg/m³. The concentration of mercury in the exit side of the permeation tube was monitored for 300 minutes.

### EXAMPLE 2

### Silica

A silica support was processed using the same preparation method accounting for differences in surface area. A typical high surface area silica was used to demonstrate air adsorption, Degussa Sipernat50 (Degussa Corp., Parsippany, N.J.) whose surface area is reported as 450 m²/g. After producing this adsorbent it had a surface area of 115 m²/g, typical of the supercritical gas process. This sample was tested the same way as the synthetic zeolite sample.

### EXAMPLE 3

### Magnetite

A quantity of magnetite (MNP-X-9002) (Magnox Specialty Pigments, Inc., Pulaski, Va.) was prepared the same as was used in Examples 1 and 2 taking the powder surface area into account. After processing this adsorbent with a starting surface area of 95-100 m²/g it had a final surface area of 80-85 m²/g, typical of the supercritical gas process. This material was processed according to the method described by Fryxell, Zemanian, et al., U.S. Pat. No. 6,531,224, and Fryxell, Zemanian, et al., U.S. Pat. No 6,753,038 (hereby specifically incorporated by reference in their entirety). This sample was tested in both as-is and dried states. In order to test different dwell times in the packed bed, the gas flow rate was increased and if necessary the bed length was shortened. The details of flow rate and concentration are shown in Table 1.

TABLE 1

| | | | | Mercury | Dwell time | |
|---|---|---|---|---|---|---|
| | [Hg]ᵢₙₚᵤₜ, | Test time, | | capture, % | in absorbent, | |
| Sample | μg/m³ | Minutes | [Hg]_{test time} | of input | sec. | |
| HS060106B, as is | 37 | 300 | 24.6 | 33.5 | 1.5 | |
| HS060106B, dried | 37.8 | 165 | 30.7 | 18.9 | 0.96 | |
| HZ060906-2, dried | 41.1 | 1320 | 32 | 22.1 | 1.29 | |
| HF07I806A, as is | 39 | 15 | 12.16 | 68.8 | 1.29 | |
| HF071806A, as is | 39 | 30 | 7.4 | 81.0 | 1.29 | |
| HF071806A, as is | 39 | 1400 | 0.48 | 98.8 | 1.29 | |
| HF071806A, dried | 29.2 | 30 | 0.05 | 99.9 | 0.65 | |
| HF071806A, dried | 29.2 | 510 | 0.223 | 99.4 | 0.65 | |
| HF071806A, dried* | 21.2 | 640 | 0.62 | 97.1 | 0.8 | sec |

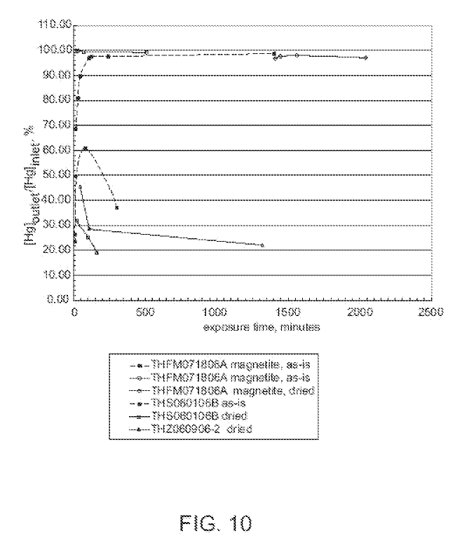

Now referring to FIG. 10, the above substrates were functionalized with a reactive group to reversibly immobilize mercury. For the silica samples (Example 2- labeled THS-060106B), as is, the silica based adsorbent was placed in the permeation tube with a dry nitrogen flow giving a dwell time of 1.5 seconds and mercury concentration of 37 μg/m³.The test showed a low initial adsorbing behavior, removing only about 22% of the mercury in the test stream. The removal rate rapidly increased to about 60% at the onset of breakthrough after which it fell rapidly to about 38% at 165 minutes exposure when the test was stopped.

The adsorbing behavior of the adsorbent with the magnetite substrate (Example 3, THF-071806A, as is condition). This sample was run with a dwell time of 1.3 seconds and mercury concentration of 39 μg/m³. The “as-is” magnetic iron oxide support shows an undesirable behavior of very little, but increasing performance up to two hours. Its adsorbing capability increased to capture about 68% of the mercury and this capture percentage increased further to 97.7% at 120 minutes and remained constant thereafter until the test was stopped at 1400 minutes. At 1400 minutes the gas flow rate was increased to reduce the bed residence time to 0.8 seconds and mercury concentration of 21.2 μg/m³. The performance showed a slight transient but continued to remove 97% of the mercury after 2040 minutes (34 hours) when the test was discontinued.

The transient at the beginning of the test suggested that some phenomenon was occurring to increase adsorbent performance. A sample on the zeolite support, the silica support and the magnetite support was given a preconditioning drying treatment of 48 hours at 74° C. using, for example, a Blue M Stabil-Therm Constant Temperature Cabinet (Blue Island, Ill.) to remove substantially all adsorbed water in the pore structure of the adsorbents. The three samples were subjected to the same type testing and this data is also shown in the figure. For the magnetite sample, THFM071806A dried the conditioned sample was run in the permeation tube with a dry nitrogen gas stream containing 29.2 μg/m³ mercury and a dwell time of 0.64 seconds for 510 minutes. This sample adsorbed 99% of the mercury until the test was stopped. The sample shows no poor transient behavior. The sample using the silica support (THS-060106B dried) subjected to the drying treatment had a low initial reduction in mercury of 32% but continually fell to lower values down to 18% by 165 minutes exposure. The sample made using the synthetic zeolite support, THZ-060906-2 dried showed about 48% reduction in mercury in the initial minutes of the test but the sample immediately reached “breakthrough” and the amount of mercury removed decreased to ˜22% after 1300 minutes of exposure.

These results show that a functionalized, magnetic carrier, such as magnetic iron oxide substrate provides high adsorbing capability of mercury in gaseous state.

While the foregoing description has set forth the various embodiments of the present invention in particular detail, it must be understood that numerous modifications, substitutions and changes can be undertaken without departing from the true spirit and scope of the present invention as defined by the ensuing claims. The invention is therefore not limited to specific preferred embodiments as described, but is only limited as defined by the following claims.

What is claimed is:

1. A method to remove an agent from a gas phase of a process system comprising the steps of:
a) suspending a magnetic carrier in said gas phase of a process system, under condition in which the agent binds to said magnetic carrier;
b) magnetically separating said magnetic carrier from said gas phase; and
c) disassociating said agent from said magnetic carrier.

2. The method of claim 1 further comprising:
a) reusing said magnetic carrier to remove agent from a gas phase of a process system.

3. The method of claim 1 wherein said magnetic carrier includes a functionalized magnetite absorbent with a surface area of at least about 1 m²/gram.

4. The method of claim 3 wherein said magnetic carrier includes a functionalized magnetite absorbent with a surface area of at least about 100 m²/gram.

5. The method of claim 1 wherein said agent is an elemental species.

6. The method of claim 5 wherein elemental species is mercury.

7. The method of claim 1 wherein said magnetic carrier is conditioned prior to use by drying to remove substantially all water adsorbed by said magnetic carrier.

8. The method of claim 1 wherein the step of suspending said magnetic carrier in said gas phase of a process system occurs in a discrete magnetic containment field.
